(19) United States
(12) Patent Application Publication
(10) Pub. No.: US 2016/0225004 A1
(43) Pub. Date: Aug. 4, 2016

(54) TOKEN VERIFICATION

(71) Applicant: BELEGIN LIMITED, Hong Kong (CN)

(72) Inventors: Richard Mark Cohen, Hong Kong (CN); Nigel James Hamilton Reid, Hong Kong (CN)

(21) Appl. No.: 14/915,416

(22) PCT Filed: Aug. 28, 2014
(86) PCT No.: PCT/IB2014/064112

§ 371 Date: Feb. 29, 2016

(30) Foreign Application Priority Data
Aug. 29, 2013 (GB) 1315385.3

(51) Int. Cl. G06Q 30/02

(52) U.S. Cl. CPC G06Q 30/0207

(57) ABSTRACT

There is provided a method of operating a server in order to generate a verification code that is to be applied to a token associated with an offer that has been claimed by a user. The method comprises determining a unique offer identifier that has been assigned to the offer (B2a), generating a unique token identifier for the token (B2b), and determining a claim number that is representative of the total number of claims of the offer that have been made by the user (B2c). The verification code is then formed by concatenating at least the unique offer identifier, the unique token identifier, and the claim number.

The present invention relates to methods and apparatus that enable the verification of a token. In particular, the present invention relates to methods and apparatus for generating a verification code that is to be applied to a token associated with an offer that has been claimed by a user via the Internet.

Over the last decade rapid advances in technology have lead to a phenomenal growth in Internet usage. In particular, access to the Internet has become easier and much more widespread due largely to the prevalence of wireless Internet technologies (such as Wi-Fi, 3G etc) and the availability of computer devices that are portable and often intuitive to use, such as smart phones and tablet computers. Furthermore, this increased Internet usage is both a result and a cause of the growth in popularity of social media and social networking websites and applications.

Unsurprisingly, businesses now recognise the importance of the Internet, and associated technologies such as email, as a medium via which they can both advertise and sell their products and/or services. For example, most businesses now have a dedicated website and social media profiles, provide e-commerce facilities, and make use of email advertising, Internet/website advertising, sponsored search engine results etc.

In addition, in order to generate interest and attract potential customers, many businesses make use of the wide-audience that can be reached via the Internet to provide offers for free or reduced cost products and/or services. This is illustrated by the current prevalence of specialist web-based offers/deals services. These services bring together offers/deals from numerous vendors/merchants that can then be accessed by members of the public, thereby attracting subscribers/visitors/customers by accumulating a large number of offers for a variety of products and/or services in one convenient location. When a customer wants to make use of an offer that is available via an offers websites, they take the actions required in order to obtain the offer (e.g. make a corresponding payment, sign-up etc), and are then provided with a token (e.g. a voucher or coupon) that indicates that they are entitled to benefit from the offer with the associated vendor/merchant. Typically the token will take the form of an electronic document or image (e.g. PDF, JPEG etc) that is either sent to the customer (e.g. by email, SMS etc) or that can be downloaded by the customer from the website. The customer can then print a hard-copy or use an image of the token that is rendered on the display of a computer device, such as a smart phone or tablet, to present the token to the associated merchant as evidence of their entitlement to the offer.

In order to confirm that the presenter of the token is entitled to the offer, the token must provide some means by which the merchant can at least partially authenticate the token itself or that the use of the token is valid. This involves applying a unique code to each token that is issued, and providing the merchant with a list of issued codes. The merchant can then determine if a token is likely to be legitimate by comparing the code applied to the token with the codes in the list, and crossing-off codes as and when an associated token is used to protect against unauthorised multiple use. Consequently, it is conventional to make use of codes that are relatively long in order to ensure that there are a sufficient number of codes available for a unique code to be applied each issued token. Furthermore, the codes are usually random or pseudorandom (e.g. generated using a one-way mathematical function) so as to ensure that one legitimate code cannot be used to determine other legitimate codes that could then be applied to forged tokens. However, having to authenticate a token in this way is a relatively slow, which can therefore delay the process of serving/dealing with a customer, causing frustration to the customer and potentially to other customers that may also be waiting for service. In addition, if the merchant has a number of points of sale (e.g. several staff and/or multiple locations) that are all required to deal with processing offers, then this authentication can become problematic, as each point of sale/supply must be provided with a copy of the list of issued codes, such that each copy of the list will become inconsistent as they will be separately maintained (e.g. codes crossed off from one list will still be present on another). Whilst this process can be semi-automated by applying a machine-readable representation of the code (e.g. barcode, QR code etc) to the token, which can then be scanned and cross-checked by a computer device, this requires a significant investment on the part of the merchant in order to ensure that they have the necessary equipment available.

It is therefore desirable to provide a means for at least partially verifying the authenticity of a token associated with an offer that can be performed quickly and manually, thereby reducing the burden on the merchant and reducing customer frustration.

Therefore, according to a first aspect there is provided a method of operating a server in order to generate a verification code that is to be applied to a token associated with an offer that has been claimed by a user. The method comprises determining a unique offer identifier that has been assigned to the offer, generating a unique token identifier for the token, and determining a claim number that is representative of the total number of claims of the offer that have been made by the user. The verification code is then formed by concatenating at least the unique offer identifier, the unique token identifier, and the claim number.

The unique offer identifier may be located at any of the start of the verification code, the end of the verification code, and within the interior of the verification code. The claim number may be located at any of the end of the verification code, the start of the verification code, and within the interior of the verification code. The unique offer identifier and the claim number may be contiguous and located at any of the start or the end of the verification code.

The method may further comprise determining where within the verification code that the unique offer identifier and the claim number are to be located, wherein the locations of one or both of the unique offer identifier and the claim number are predefined for the offer. In this case, the locations of one or both of the unique offer identifier and the claim number for the offer may then be defined by inputs received by the server during the creation of the offer. Alternatively, the locations of one or both of the unique offer identifier and the claim number for the offer may be selected by the server during the creation of the offer.

The method may further comprise determining a unique user identifier that has been assigned to the user, and the step of forming the verification code may then comprises concatenating at least the unique offer identifier, the unique token identifier, and the claim number with the unique user identifier.

The step of forming the verification code may comprise concatenating at least the unique offer identifier, the unique user identifier, the unique token identifier, and the claim number with one or more further pseudorandom strings.

According to a second aspect there is provided a computer program comprising computer readable code which, when run on a computer device, causes the computer device to perform the method according to the first aspect.

According to a third aspect there is provided computer program product comprising a computer readable medium and a computer program according to the second aspect, wherein the computer program is stored on the computer readable medium.

According to a fourth aspect there is provided a system for generating a verification code that is to be applied to a token associated with an offer that has been claimed by a user. The system comprises a processor configured to determine a unique offer identifier that has been assigned to the offer, generate a unique token identifier for the token, and determine a claim number that is representative of the total number of claims of the offer that have been made by the user. The processor is then configured to form the verification code by concatenating at least the unique offer identifier, the unique token identifier, and the claim number.

The processor may be configured to locate the unique offer identifier at any of the start of the verification code, the end of the verification code, and within the interior of the verification code.

The processor may be configured to locate the claim number at any of the end of the verification code, the start of the verification code, and within the interior of the verification code.

The processor may be configured to combine the unique offer identifier and the claim number such that they are contiguous and to locate the combination of the unique offer identifier and the claim number at an end of the verification code.

The system may further comprise a memory configured to store information relating to the offer that predefines the locations of one or both of the unique offer identifier and the claim number. The processor is then further configured to use the offer information to determine where within the verification code the unique offer identifier and the claim number are to be located.

The system may further comprise a receiver configured to receive inputs during the creation of the offer that define the locations of one or both of the unique offer identifier and the claim number. The processor is then further configured to store the defined locations in the memory.

The processor may be further configured to select locations for one or both of the unique offer identifier and the claim number during the creation of the offer and to store the selected locations in the memory.

The processor may be further configured to determine a unique user identifier that has been assigned to the user, and to form the verification code by concatenating at least the unique offer identifier, the unique token identifier, and the claim number with the unique user identifier.

The processor may be configured to form the verification code by concatenating at least the unique offer identifier, the unique user identifier, the unique token identifier, and the claim number with one or more further pseudorandom strings.

The present invention will now be more particularly described by way of example only with reference to the accompanying drawings, in which:

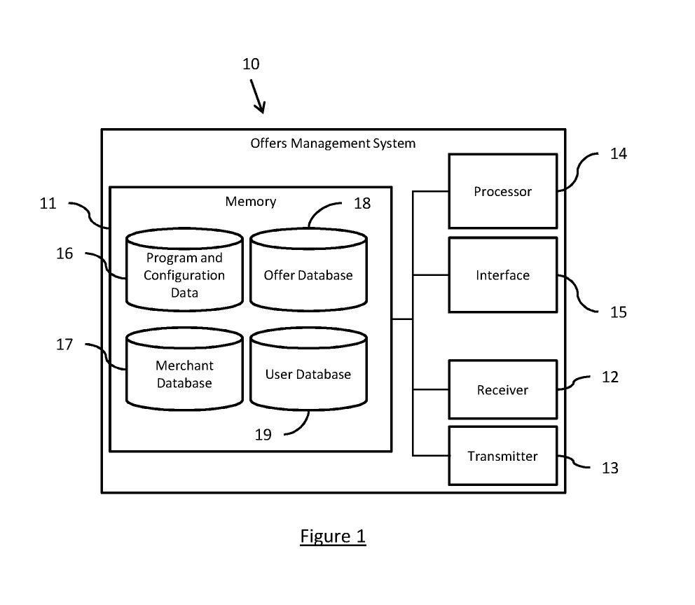

FIG. 1 illustrates schematically an embodiment of a system suitable for implementing the methods described herein;

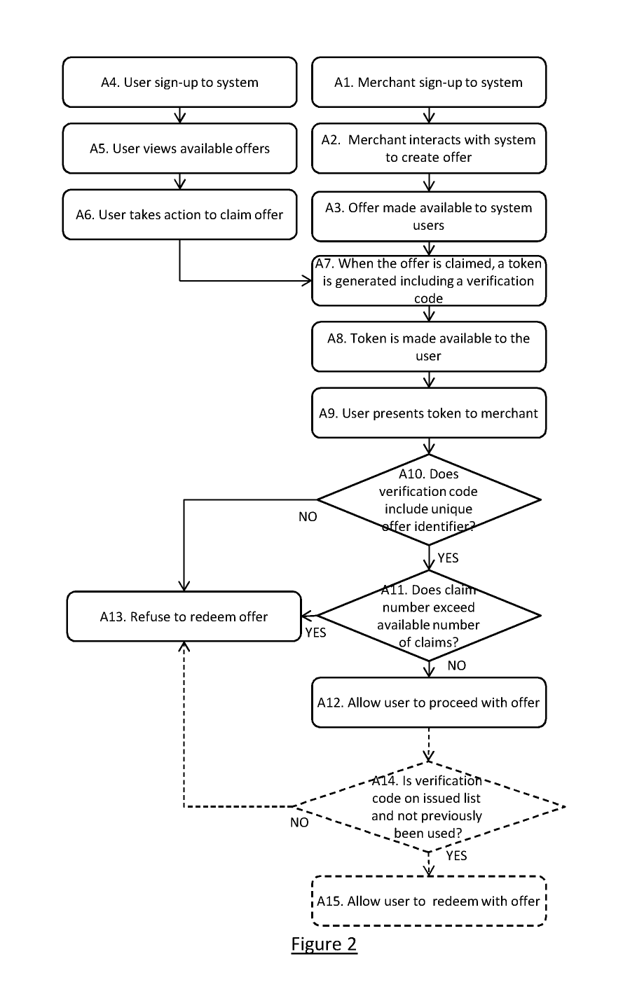

FIG. 2 is a flow diagram illustrating an embodiment of a method of enabling users to obtain offers via the Internet as described herein; and

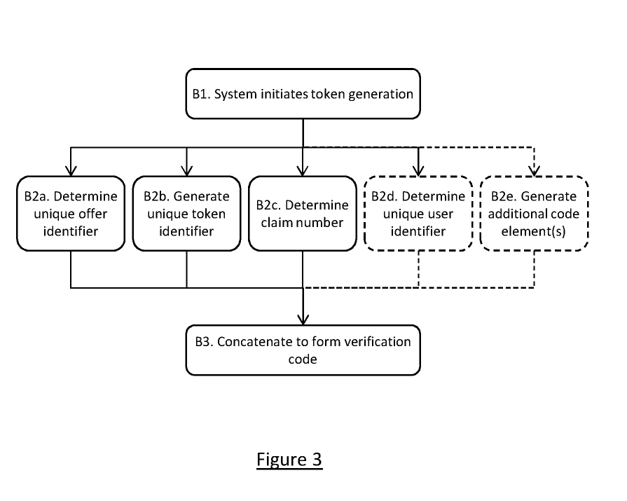

FIGS. 3 is a flow diagram illustrating an embodiment of a method of generating a verification code that is to be applied to a token associated with an offer that has been claimed by a user.

There will now be described a system that enables users (e.g. customers) to obtain offers relating to products and/or services via the Internet, wherein the offers are made available to users of the system by one or more merchants. In particular, for a user that has claimed an offer that is available via the system, the system generates a token, applies a verification code to the token, and provides the user with the token as evidence that the user is entitled to the offer. The verification code generated by the system is constructed so as to allow the merchant to quickly and manually perform at least a partial verification of the token when the user presents the token to the merchant at the point of sale/supply. To do so, the system generates/forms the verification code by concatenating at least a unique offer identifier, a unique token identifier, and a claim number.

The unique offer identifier is an identifier for the offer that is unique across all offer identifiers assigned by the system, and is typically assigned to the offer at the time at which the offer is created/added to the system by the associated merchant. The unique token identifier is an identifier for the token that is unique across all token identifiers assigned by the system, and is assigned to the token at the time at which the token is generated. The unique offer identifier and the unique token identifier are strings (i.e. sequences of characters) that can be any of numeric or alphanumeric. The claim number is representative of the total number of claims of a particular offer that have been made by a user, and will typically be a numeric string.

Concatenation therefore involves linking together at least these strings so as to form a chain or series. For example, the concatenation of the strings that are included in the verification code could result in a single contiguous string of numeric or alphanumeric characters in which each of the individual strings are joined end-to-end. Alternatively, the concatenation of the strings that are included in the verification code could result in single contiguous string in which the individual strings of numeric or alphanumeric characters are linked/joined together by non-alphanumeric characters, such as punctuation marks or white space characters.

Such a verification code allows the merchant to determine whether a token presented by a user (i.e. a customer) is a legitimate token generated by the system, and to determine whether or not a particular token has already been redeemed, by performing a full comparison of the verification code that has been applied to the token with a list of verification codes issued by the system for the merchant's offer. However, such a verification code also provides that a merchant can very quickly and easily make an initial determination as to whether or not the token is likely to be legitimate by simply checking whether the unique offer identifier assigned to the offer is present within the verification code, without the need to refer to a list of verification codes provided by the system. This is possible as the unique offer identifier is constant across all tokens issued for a particular offer, and can be relatively short and easy to remember. Furthermore, even if a merchant makes several different offers available, it is relatively straightforward for the merchant to remember a unique offer identifier for each of the offers, and check for the appropriate unique offer identifier within a verification code, rather than having to constantly and instantaneously manage a list of issued verification codes for each offer.

The inclusion of the claim number within the verification code also strengthens this quick verification procedure, as attempts to falsify the verification code on forged tokens may result in a verification code in which the element of the code that should represent the claim number exceeds the number of offers that the merchant has made available to each user. This would be readily identifiable to the merchant who would be aware of which element of the code represents the claim number. By way of example, when making an offer available, a merchant may specify that each user is only entitled to make use of an offer once, and the claim number “001” may then be placed at the end of the verification code. Then, if an individual attempts to generate a forged token without a complete understanding as to how the verification code is constructed, they may assume that this number should increase for each token issued, and therefore use a false verification code that ends with a number greater than “001”. The merchant can then easily see that this second token exceeds the number of offers available per user and can refuse to redeem the offer on this basis. If a merchant does not choose to apply a limit on the number of offers that are available to each user, then the system could be configured to set the claim number to zero.

In addition, by including the claim number within the verification code, it is not necessary for the system to actively enforce a limit on the number of offers that are available to each user, as the merchant can quickly and easily determine if a user has been issued with more than the number of offers that are available. By way of example, when making an offer available, a merchant may specify that each user is only entitled to make a single claim of an offer, and this would be clearly displayed to users when viewing and/or claiming the offer. Then, if a single user makes two claims of this offer, the verification code applied to the token issued in relation to the second claim will include a claim number indicating that this is the user's second claim for this offer (e.g. “2”, “02”, “002” etc). The merchant can then easily see that this second token exceeds the number of offers available per user and can refuse to redeem the offer on this basis. Consequently, the system itself is not required to actively enforce the limit by refusing to issue further tokens, reducing the processing burden placed on the system. However, if it would be desirable, then the system could be configured to enforce the limit on the number of offers that are available to each user as defined by the merchant when creating the offer on the system.

The inclusion of a unique token identifier ensures that each verification code is unique to each token issued, and provides at least one element of the verification that assists in obscuring the construction of the code. For example, without the unique token identifier, the verification code applied to two different tokens issued to the same user for a single offer would only vary by the claim number, as the unique offer identifier would be constant for both tokens. However, by including a unique token identifier that varies for each token issued, the variance in this element of the code and the element representing the claim number will at least partially obscure the construction of code. Furthermore, by providing that the unique token identifier is either random or pseudorandom, the inclusion of the unique token identifier can ensure that one legitimate code cannot be used to determine other legitimate codes that could then be applied to forged tokens.

When forming the verification code, the unique offer identifier can be placed either at the start or at the end of the verification code. If the unique offer identifier is placed at the start of the verification code, then the claim number can be placed at the end of the verification code. Alternatively, if the unique offer identifier is placed at the end of the verification code, then the claim number can be placed at the start of the verification code. As a further alternative, the unique offer identifier and the claim number can be located adjacent to one another (i.e. such that they are contiguous), and the combination of the unique offer identifier and the claim number can then be placed at either the start or the end of the verification code. Constructing the verification code in this way makes it easy for the merchant to locate the unique offer identifier and the claim number within the verification code.

As a further alternative, the unique offer identifier and/or the claim number could be located in the interior of the verification code (i.e. away from the start or end), such that other elements that make up the verification code are located between the unique offer identifier and/or the claim number and the start or end of the verification code. Locating one or both of the unique offer identifier and the claim number within the interior/central part of the verification code could induce a slight delay when the merchant is attempting to determine if the unique offer identifier and the claim number are correct, as they would be less immediately evident. However, provided the merchant is aware of the location of the unique offer identifier and the claim number, this should not induce a significant delay. In particular, when the offer is created by the merchant and the unique offer identifier assigned to the offer, the system could be configured to either allow the merchant to chose the location within the verification code of one or both of the unique offer identifier and the claim number, or to automatically select the locations of one or both of the unique offer identifier and the claim number and to inform the merchant of the selected location(s). In addition, if one or both of the unique offer identifier and the claim number are to be located within the interior of the verification code, the system could be configured to introduce some separation between the elements of the verification code when the verification code is displayed on the token using non-alphanumeric characters. For example, the system could be configured to introduce a small space, hyphen or underscore between the different elements of the verification code so as to make the separate elements more evident.

The system can also be configured to concatenate the unique offer identifier, the unique token identifier, and the claim number with a unique user identifier. In this regard, a unique user identifier is an identifier for the user that has claimed the offer, with this identifier being unique across all user identifiers assigned by the system, and is typically assigned to the user when the user subscribes to or enrols with the system. The unique user identifier would be a string (i.e. a sequence of character) that can be any of numeric or alphanumeric. The inclusion of the unique user identifier enables the administrators/managers of the system to identify the user to whom a token has been issued. This can be useful should any problems arise and/or any errors occur that require investigation. Furthermore, the inclusion of the unique user identifier provides a further element of the verification that assists in obscuring the construction of the code, thereby increasing the difficulty of generating forged tokens that appear legitimate.

Moreover, the system can also be configured to concatenate the unique offer identifier, the unique token identifier, the claim number and optionally the unique user identifier with one or more further pseudorandom strings. For example, a pseudorandom string generated by a one-way algorithmic transformation of the offer title/name could be added into the verification code in order to strengthen the overall authentication provided by the verification code, and further obscure the construction of the code.

FIG. 1 illustrates schematically an embodiment of an offer management system 10 suitable for implementing the methods described herein. The system 10 can be implemented as a combination of computer hardware and software, and comprises a memory 11, a receiver 12, a transmitter 13, a processor 14 and an interface 15. Whilst the system 10 has been illustrated schematically as single device (e.g. server or computer) comprising a single occurrence of each of the functional elements listed above, the system could equally comprise multiple occurrences of each functional element and could equally be provided by a plurality of separate devices that cooperate to provide the required functionality. By way of example, separate aspects of the functionality of the system could be distributed between a number of separate servers or computer devices, such that a first group of one or more servers/computer devices implements all of the necessary processing and interface functions whilst a second group of one or more servers/computer devices provides database functionality (e.g. including storage, security, data integrity, data redundancy etc).

The memory 11 typically stores the various programs/executable files that are implemented by the processor 14, any system configuration data 16, and any other data that may be of use to the system 10. In particular, the data stored by the memory 11 can include but is not limited to a merchant database 17, an offer database 18 and a user database 19. The merchant database 17 could be configured to store the information relating to each merchant that has enrolled with the system, such as the merchant's username and password, the detailed information of the merchant, and at least a reference to each of the offers created by the merchant. The offer database 18 could be configured to store the information relating to each offer that has been created/made available by the merchants, the unique offer identifier assigned to the offer, and a list of tokens and/or verification codes that have been issued for each offer. The user database 19 could be configured to store the information relating to each user, including the unique user identifier assigned to each user, the user's login information (e.g. username and password), the user's contact information (e.g. email address, physical address, phone number etc) etc. The user database 19 could also be configured to store information regarding the offers claimed by each user.

The receiver 12 is configured to receive data that is sent to the system 10. For example, this data will typically comprise Internet communications from merchants and users of the system, such as data inputs supplied to a website provided by the system 10. The transmitter 13 is configured to send data from the system 10. For example, this data will typically comprise Internet communications intended for merchants and users of the system, such as data relating to a website provided by the system and responses to data inputs, as well as emails and/or SMS/text messages.

The processor 14 is configured to implement the processing necessary to provide a web-based offers service as described herein. As such, the processor 14 is configured to implement any of the functionality required in order to execute any of the processes, perform any of the actions, and maintain any items of data described herein. In particular, the processor is 14 is configured to enable merchants to sign-up to the system, and create and edit offers that are to be made available to users of the system. In addition, the processor is 14 is configured to enable users to sign-up to the system and view and claim offers made available by merchants that use the system 10. The processor 14 is therefore also configured to generate a token that can be presented to a merchant as evidence that the user is entitled to benefit from an offer provided by the merchant, including the generation of a verification code that is to be applied to the token.

The interface 15 is configured to allow the merchants and users to interact with the system 10 (e.g. in order to sign-up to the system, view/update/modify any appropriate data etc). For example, the interface 15 can be implemented as a web-based user interface or portal through which merchants and users can login to the system 10 and access the data and the functions provided by the system 10.

FIG. 2 is a flow diagram illustrating an embodiment of a method of enabling users to obtain offers relating to products and/or services via the Internet, wherein the offers are made available to users of the system by one or more merchants. The steps performed are as follows:

A1. A merchant that wishes to make an offer available to users of the system signs up to/enrols with the system 10 using the web-based interface 15 (e.g. a website or app), and creates a merchant profile that is saved into the memory of the system 11. For example, this sign-up procedure may follow a conventional process in which the merchant provides a number of items of detailed information (e.g. name, address, website, phone number, email address etc) and establishes a username and password combination that allows them to log-in to the system 10 as a merchant. By logging into the system 10, the merchant can then access and manage their information via the web-based interface 15, and create and amend any of their offers.

A2. The merchant then uses the web-based interface 15 to create an offer that is to be made available to users of the system 10. For example, this process can involve specifying the details of the offer, the number of claims of the offer that can be made by each user, and even one or more criteria that must be met by a user in order to be able to view, claim, and/or redeem the offer (e.g. location, age etc). As part of this process the processor 14 will also generate a unique offer identifier for the offer, and present/communicate the unique offer identifier to the merchant. The offer information will be stored in the offer database 18 and may also be stored or cross-referenced within the record of the associated merchant in the merchant database 17.

A3. The offer created by the merchant is then made available (e.g. to be viewed and/or claimed) to users of the system 10. In this regard, when the offer is available to a user, the user will be able to view the details of the offer using the web-based interface 15. The offer may be made available to all of the users of the system or only to those users that meet any criteria that are specified by the merchant.

A4. An individual that wishes to claim an offer that is made available by the system 10 signs up to/enrols with the system using the web-based interface 15 (e.g. a website or app), and creates a user profile that is saved into the memory 11 of the system 10. For example, this sign-up procedure may follow a conventional process in which the user provides a number of items of detailed information (e.g. name, address, phone number, email address etc) and establishes a username and password combination that allows them to log-in to the system as a user. As part of this process the processor 14 will also generate a unique user identifier for the user. The user information including the unique user identifier will then be stored in the user database 19. By logging into the system 10, the user can then access and manage their information via the web-based interface 15, and view and claim any offers that are available to the user.

A5. The user then views the offers that are available to them using the web-based interface 15.

A6. When the user identifies an offer that they wish to claim, the user makes use of the web-based interface 15 to take any action necessary for claiming the offer. For example, this may involve simply indicating that they wish to claim the offer by using an associated GUI widget provided by the interface 15 and/or may involve making at least a partial payment for the offer.

A7. When the user has taken any action necessary to claim the offer, the processor 14 generates a token for the user, including the generation of a unique verification code and the application of the verification code to the token. The process of generating a verification code is described below with respect to FIG. 3.

A8. The token bearing the verification code is then made available to the user. For example, an image file representing the token and including the verification code can be sent to the user in an email or SMS message using the transmitter 13, or can be made available for the user to download from the Internet.

A9. Having obtained the token, the user then presents this token to the merchant at the merchant's point of sale/service as evidence that they are entitled to benefit from the offer.

A10. When presented with the token, the merchant can perform a quick initial authentication of the token by confirming that the verification code applied to the token includes the unique offer identifier associated with the offer. If the verification code does include the unique offer identifier associated with the offer, then the process proceeds to step A11. If the verification code does not include the unique offer identifier associated with the offer, then the process proceeds to step A13.

A11. If the verification code does include the unique offer identifier associated with the offer, then the merchant can also confirm that the claim number included within the verification code does not exceed the number of claims of the offer that that the merchant has made available to each user. If the claim number does not exceed the maximum number of allowed claims, then the process proceeds to step A12. If the claim number does exceed the maximum number of allowed claims, then the process proceeds to step A13.

A12. If the verification code does include the unique offer identifier associated with the offer and the claim number does not exceed the maximum number of allowed claims, then the merchant can allow the user to proceed with the offer. Optionally, the process can proceed to step A14.

A13. If the verification code does not include the unique offer identifier associated with the offer and/or the claim number does exceed the maximum number of allowed claims, then the merchant can refuse to redeem the offer and the process ends.

A14. Optionally (as indicated by the dashed lines), if the merchant deems it necessary, then the merchant can subsequently perform a full authentication of the verification code by comparison against a list of verification codes for tokens issued by the system. For example, the quick initial authentication of the token implemented in steps A10 and A11 could be performed by the merchant immediately upon presentation of the token by the user so as to minimise any delay in service that could be caused by the authentication process. A full authentication of the verification code could then be implemented subsequently, when the merchant has more time available and when doing so would not induce any delay.

A15. In this case, if the verification code is on a list of issued tokens and the verification code has not been found on a previously used token, then the merchant can allow the user to redeem the offer. Otherwise, the merchant can refuse to redeem the offer.

FIG. 3 is a flow diagram illustrating an embodiment of a method of generating a verification code that is to be applied to a token associated with an offer that has been claimed by a user. The steps performed are as follows:

B1. The process is initiated during the generation of the token by the system.

B2a. The system determines the unique offer identifier that has been assigned to the offer. For example, this could involve performing a lookup in the offer database. Alternatively, the unique offer identifier could be associated with/linked to the information available to the system when the user claims the offer (e.g. be contained within metadata associated with a webpage presenting the offer) and could therefore be obtained directly.

B2b. The system generates a unique token identifier for the token. This could involve generating a pseudorandom string using a one-way mathematical function that is applied to some information associated with the token. For example, this could involve applying a cryptographic hash function to data representing the offer and the date and time at which the claim was made.

B2c. The system determines a claim number that is the number claims of this offer made by the user. For example, this may involve performing a lookup in either the offer database or the user database to determine how many times this offer has previously been claimed by the user. Expanding upon this example, the system could search within the offer database for previously issued verification codes that include the unique offer identifier of the offer and the unique user identifier of the user. The claim number can be represented by any number of digits, as appropriate. For example, the claim number could be represented by a single digit (i.e. “0” to “9”) or multiple digits (e.g. “01”, “001”, “0001” etc).

B2d. Optionally (as indicated by the dashed lines), the system can determine the unique user identifier that has been assigned to the user. For example, this could involve performing a lookup in the user database to determine the unique user identifier associated with the user's username.

B2e. Optionally (as indicated by the dashed lines), the system can also generate one or more further random or pseudorandom code elements in order to further obscure the construction of the verification code.

B3. The verification code is then formed by concatenating the unique offer identifier, the unique token identifier, the claim number, and any other code elements (e.g. the unique user identifier, other pseudorandom code elements etc).

The order in which the elements of the verification code are combined could be defined globally for the system so that the same order is used for each offer and verification code generated. Alternatively, the system could select/define the order used when generating the verification codes associated with a particular offer, and communicate the order to the merchant when the offer is created. As a further alternative, the system could be configured to allow the merchant to select the order when creating the offer, so as to allow the merchant to select an order that they believe to be most suitable. In this regard, if the order, and in particular the location of the unique token identifier and the claim number, are defined for each offer (i.e. are chosen by the merchant or selected by the system), then the order in which the elements are to be concatenated for that offer will be stored in the memory of the system (i.e. in the offer database). The step of concatenating the elements to form the verification code (see step B3) would then be proceeded by a step in which the processor determines the order/location of the elements of the verification code for offer by retrieving the order stored in the memory.

It will be appreciated that individual items described above may be used on their own or in combination with other items shown in the drawings or described in the description and that items mentioned in the same passage as each other or the same drawing as each other need not be used in combination with each other. In addition, the expression “means” may be replaced by actuator, system, unit or device as may be desirable. In addition, any reference to “comprising” or “consisting” is not intended to be limiting in any way whatsoever and the reader should interpret the description and claims accordingly.

Furthermore, although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims.

1. A method of operating a server in order to generate a verification code that is to be applied to a token associated with an offer that has been claimed by a user, the method comprising:
determining a unique offer identifier that has been assigned to the offer;
generating a unique token identifier for the token;
determining a claim number that is representative of a total number of claims of the offer that have been made by the user; and
forming the verification code by concatenating at least the unique offer identifier, the unique token identifier, and the claim number.

2. (canceled)

3. (canceled)

4. (canceled)

5. (canceled)

6. (canceled)

7. (canceled)

8. The method of claim 1, wherein the unique offer identifier and the claim number are contiguous and are located at any of the start or the end of the verification code.

9. The method of claim 1, further comprising:
determining where within the verification code the unique offer identifier and the claim number are to be located, wherein the locations of one or both of the unique offer identifier and the claim number are predefined for the offer.

10. The method of claim 9, wherein the locations of one or both of the unique offer identifier and the claim number for the offer are defined by inputs received by the server during the creation of the offer.

11. The method of claim 9, wherein the locations of one or both of the unique offer identifier and the claim number for the offer are selected by the server during the creation of the offer.

12. The method of claim 1, further comprising determining a unique user identifier that has been assigned to the user, wherein the step of forming the verification code comprises concatenating at least the unique offer identifier, the unique token identifier, and the claim number with the unique user identifier.

13. The method of claim 1, wherein the step of forming the verification code comprises concatenating at least the unique offer identifier, the unique token identifier, and the claim number with one or more pseudorandom strings.

14. A computer program comprising computer readable code which, when run on a computer device, causes the computer device to perform the method of claim 1.

15. A computer program product comprising a computer readable medium and the computer program of claim 14, wherein the computer program is stored on the computer readable medium.

16. A system for generating a verification code that is to be applied to a token associated with an offer that has been claimed by a user, the system comprising a processor configured to:
determine a unique offer identifier that has been assigned to the offer;
generate a unique token identifier for the token;
determine a claim number that is representative of a total number of claims of the offer that have been made by the user; and
form the verification code by concatenating at least the unique offer identifier, the unique token identifier, and the claim number.

17. (canceled)

18. (canceled)

19. (canceled)

20. (canceled)

21. (canceled)

22. (canceled)

23. The system of claim 16, wherein the processor is configured to combine the unique offer identifier and the claim number such that they are contiguous and to locate the combination of the unique offer identifier and the claim number at any of the start or the end of the verification code.

24. The system of claim 16, further comprising a memory configured to store information relating to the offer that predefines the locations of one or both of the unique offer identifier and the claim number, wherein the processor is further configured to use the offer information to determine where within the verification code the unique offer identifier and the claim number are to be located.

25. The system of claim 23, further comprising a receiver configured to receive inputs during the creation of the offer that define the locations of one or both of the unique offer identifier and the claim number, and the processor is further configured to store the defined locations in the memory.

26. The system of claim 23, wherein the processor is further configured to select locations for one or both of the unique offer identifier and the claim number during the creation of the offer and to store the selected locations in a memory.

27. The system of claim 16, wherein the processor is further configured to determine a unique user identifier that has been assigned to the user, and to form the verification code by concatenating at least the unique offer identifier, the unique token identifier, and the claim number with the unique user identifier.

28. The system of claim 16, wherein the processor is configured to form the verification code by concatenating at least the unique offer identifier, the unique user identifier, the unique token identifier, and the claim number with one or more pseudorandom strings.
